(19) United States
(12) Patent Application Publication
(10) Pub. No.: US 2021/0248334 A1
(43) Pub. Date: Aug. 12, 2021

(54) SYSTEM AND METHOD OF SHARING A USER PROFILE

(71) Applicant: Ferdell Baker, Charlotte, NC (US)

(72) Inventor: Ferdell Baker, Charlotte, NC (US)

(21) Appl. No.: 17/240,757

(22) Filed: Apr. 26, 2021

Related U.S. Application Data
(60) Provisional application No. 63/016,100, filed on Apr. 27, 2020.

(51) Int. Cl. G06K 7/10; H04W 12/033; G06K 19/07; G06F 16/903; H04L 29/08

(52) U.S. Cl. CPC G06K 7/10297; H04W 12/033; A44B 9/16; G06F 16/90335; H04L 67/306; G06K 19/0723

(57) ABSTRACT

The present invention is directed to a secured system for sharing a user profile comprising an NFC secured tag, the NFC secured tag containing a unique security code, the unique security code associated with a user profile, the NFC secured tag configured to be read by an NFC enabled electronic device; a wearable accessory including the NFC secured tag; a database storing the user profile; a server in electric communication with the database, the server including a processor and a memory in communication with the processor, wherein the memory stores a set of instructions executable by the processor, the set of instructions when executed by the processor, cause the processor to read the unique security code by the NFC enabled electronic device from the NFC secured tag; receive the unique security code from the NFC enabled electronic device; query the unique security code in the database; retrieve the user profile associated with the unique security code from the database; and present the user profile onto the NFC enabled electronic device.

### CROSS-REFERENCE TO RELATED APPLICATIONS

This application claims priority to the U.S. provisional patent application Ser. No. 63/016,100 filed on Apr. 27, 2020, which is incorporated herein by reference in its entirety.

### FIELD OF INVENTION

The present invention relates to a secured system and method for sharing a user profile, and, in particular, the present invention relates to a secured system and method for relating the user profile with an NFC secured tag.

### BACKGROUND

In day-to-day interactions, it is common for the persons exchanging contact data. The interactions can be business interaction or social interactions. For example, in business interactions, the contact information is often shared by the physical exchange of business cards. Also, known are digital contact cards, such as vCard's for sharing contact information over a network, such as an internet or Bluetooth. In social interaction, the person usually shares their contact information by writing down their contact details. Digital personal profiles or resume are also known which allows a user to send requests in the form of links.

Thus, a need is appreciated for an improved system and method that allows quick secured sharing of personal profiles of users.

### SUMMARY OF THE INVENTION

The principal object of the present invention is therefore directed to a system and method for providing a tag that uniquely identifies a person.

It is a further object of the present invention that the secured system and method allow exchanging user profiles in a secure environment.

It is still a further object of the present invention that the system and method allow for quick sharing of user profiles via NFC secured tag.

In one aspect, disclosed is a system and method that allows a person to share their profile with other persons securely. The system includes an NFC secured tag containing a unique security code, wherein the unique security code is associated with a user profile. The NFC secured tag can be read by an NFC enabled electronic device.

In one aspect, the system further comprises a server, wherein the server includes a database for storing the personal profiles of users. The server can receive a query from the NFC enabled electronic device, wherein the query includes the unique security code associated with a specific user profile. The server query the database with the query and retrieve the user profile associated with the unique security code by the server.

In one aspect, the NFC secured tag can be configured in a wearable accessory. The wearable accessory can be a badge having a fastener. The fastener configured to couple the badge with an article of clothing. In one case, the fastener can be a cloth pin, a hook and loop fastener, or a snap button.

In one aspect, the server can connect to an NFC enabled electronic device through a network. The server configured to provide an interface onto the NFC enabled electronic device. The interface including an option to read the NFC secured tag, receive a user profile from the server, viewing the user profile, and allowing a user to update their profile.

These and other objects and advantages of the embodiments herein will become readily apparent from the following detailed description.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a front view of a wearable badge, according to an embodiment of the present invention.

FIG. 2 is a rear view of the wearable badge of FIG. 1 showing the clothes pin for attaching the wearable badge to an article of clothing, according to an exemplary embodiment of the present invention.

FIG. 3 is a block diagram showing the system, according to an exemplary embodiment of the present invention.

FIG. 4 is an environment diagram showing the server connected to an NFC enabled electronic device, according to an exemplary embodiment of the present invention.

FIG. 5 is a flowchart showing an embodiment of the registration module, according to the present invention.

FIG. 6 is a flowchart showing an embodiment of the profile module, according to the present invention.

FIG. 7 is a flowchart showing an embodiment of the NFC security and query module, according to the present invention.

FIG. 8 shows an embodiment of an interface, according to the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation.

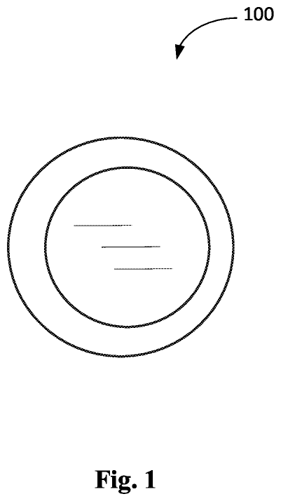

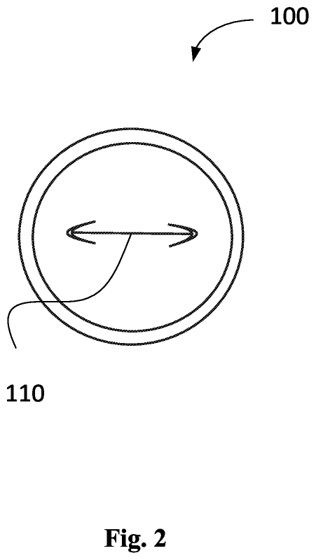

The present disclosure discloses an NFC secured system and method of sharing user profiles. The system and method disclosed herein allow a user to share his profile with other users. The profile of a user can include a biodata of the user. Now referring to FIG. 1 which shows one embodiment of an NFC secured tag incorporated into a badge 100. The badge 100 can be worn over an article of clothing, such as a shirt. FIG. 2 shows a rear side of the badge 100 having a clothes pin 110 that allows the badge to be worn over the article of clothing. The badge 100 can be configured with an NFC secured tag, wherein the NFC secured tag included a unique identification code. The unique identification code can be an alphanumerical code that can be linked to a user personal profile. The unique identification code can be read by any NFC enabled electronic device, such as a smartphone. It is to be noted that the invention has been illustrated using the example of the badge, however, a skilled person will appreciate that the NFC secured tag can be configured in any other device, such as a watch without departing from the scope of the present invention. Moreover, FIG. 1 shows the badge of disc shape, it is however obvious that the badge can be produced in different shapes and colors. The badge can include aesthetic designs, such as letters and symbols. Additionally, the badge can be coated with a layer having aesthetic design. An aesthetic design can also be interchangeably incorporated into the badge. The badge can be manufactured of plastic or metallic materials. In one case, the badge is made of metal and having a coating of an aesthetic design. In one case, the badge can be made of a transparent acrylic material incorporating an aesthetic design.

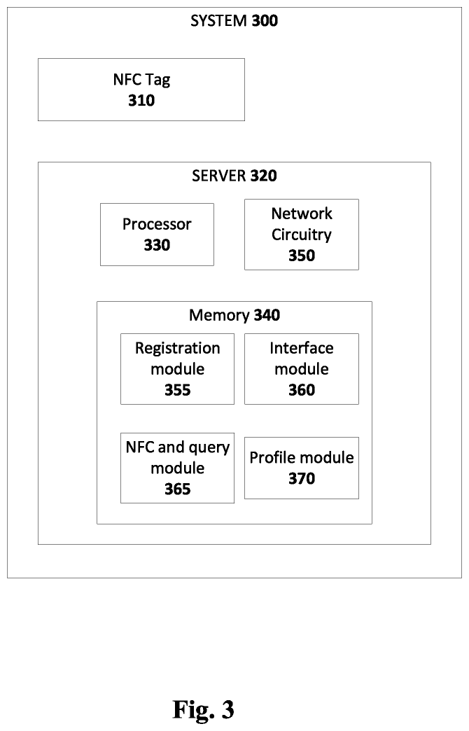

FIG. 3 is a system diagram showing the system 300 having an NFC secured tag 310 and a server 320. According to one implementation, the system 300, disclosed herein, may include a single or multiple, logically grouped servers. In one case, the servers may be geographically dispersed. One or more of the servers can include an operating system platform, for example, Windows, Unix, Linux, or Mac. Furthermore, the server 320 can include a processor 330, a memory 340, and a network circuitry 350, wherein the memory 340 and the network circuitry 350 are in electronic communication with the processor 330.

In one implementation, the processor 330 can be any logic circuitry that responds to and processes instructions fetched from the memory 340. In certain embodiments, the processor can be a microprocessor unit, e.g., Intel processors and AMD processor. The server 320 may be based on any of these processors, or any other processor capable of operating as described herein.

The memory 340 may include one or more memory chips capable of storing data and allowing any storage location to be directly accessed by the processor 330. The memory 340 may be a volatile memory, including Dynamic random access memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the memory 340 may be non-volatile; e.g., Non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The memory 340 may be based on any of the above-described memory chips, or any other available memory chips capable of operating as described herein.

As shown in FIG. 3, the memory 340 can include one or more modules that when executed by the processor 330 causes the processor 330 to perform one or more disclosed steps of a method. FIG. 3 shows the memory 340 including a registration module 355, an interface module 360, NFC and query module 365, and a profile module 370.

The NFC secured tag 310 includes a unique identification code generated by the registration module 355. Alternatively, the NFC secured tag 310 can include a preset unique identification code that can be registered by the registration module 355. The unique identification code is linked to a user profile. As discussed above, the NFC secured tag can be integrated into a wearable accessory, such as a watch or badge shown in FIG. 1. NFC secured tags can be securely configured into the wearable accessory, such as to prevent tampering of the NFC secured tag. In one case, the unique identification code can be written to the NFC secured tag as read-only. In one case, the unique identification code can be encrypted and only authorized devices with the unique application can decrypt the encrypted unique identification code. Such authorization can be provided by the NFC and query module 365. In one case, the NFC secured tag 310 can be accessed only by any authorized NFC reader. Any NFC reader, such as an NFC enabled smartphone can be authorized to read the NFC secured tag 310 by the NFC and query module 365. In one case, the NFC secured tag 310 can be a passive tag drawing power from the NFC reader. Alternatively, a battery can be provided with the NFC secured tag into the wearable accessory.

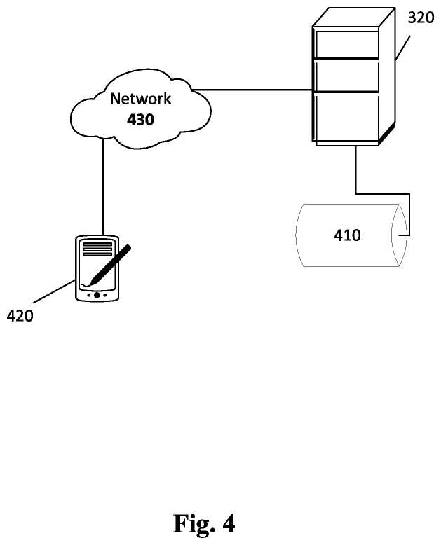

FIG. 4 is an environment diagram showing server 320 connected to a database 410. The database 410 can store and index the user profiles, such as a particular user profile that can be queried by the NFC and query module 365. The user profiles can be stored, retrieved, updated, and indexed by the profile module 370. Moreover, the profile module 370 can provide for encryption and decryption of the database 410. The server 320 can further connect to one or more NFC enabled electronic devices 420 through a network 430.

The network 430 can be wired or wireless network. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel or satellite band. The wireless network may also include any cellular network standards used to communicate among mobile devices, including standards that qualify as 3G, 4G, or 5G. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. The geographical scope of the network 130 may vary widely and the network 130 can be a body area network (BAN), a personal area network (PAN), a local-area network (LAN), e.g. Intranet, a metropolitan area network (MAN), a wide area network (WAN), or the Internet. The network 430 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include the application layer, transport layer, internet layer (including, e.g., IPv6), or the link layer. The network 430 may be a type of a broadcast network, a telecommunications network, a data communication network, or a computer network.

The one or more one or more NFC enabled electronic devices 420 can be authorized by the system 300 as NFC readers that can read the unique security code configured onto the NFC secured tag 310. In one case, the NFC enabled electronic devices 420 can be a smartphone with NFC circuitry, a tablet computer with NFC circuitry, or a similar electronic device with the NFC circuitry. The NFC enabled electronic devices 420 can include an operating system, such as Android, iOS, and Windows. Moreover, the NFC enabled electronic devices 420 can be provided with an application that may allow the NFC enabled electronic devices 420 to communicate with the system 300 disclosed herein. Such an application can be developed for the known operating system of the NFC enabled electronic devices 420, for example, the application can be developed for Android, iOS, and Windows. The application software can be made available through a distribution service provider, for example, Google Play operated and developed by Google and the app store by Apple. In addition to the application software, a website-based interface can also be provided through the world-wide-web. In one case, the network 430 can be secured through known encryption, such as SSL. Also, it is to be understood that FIG. 3 shows the memory 340 to include various modules which can be executed by the processor 330 to perform one or more steps of the method disclosed herein, however, one or more steps can also be performed on the NFC enabled electronic devices 420. Similarly, one or more modules can also be stored in a memory of the NFC enabled electronic devices 420 and executed by a processor of the NFC enabled electronic devices 420. Also, FIG. 4 shows a database 410 for storing the user profiles as a separate element, however, the database 410 can be configured into the server 320 itself. Moreover, one or more profiles can also be stored into the memory of the NFC enabled electronic devices 420.

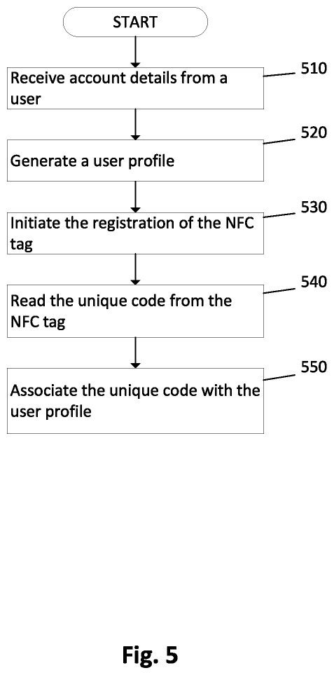

FIG. 5 shows an implementation of the registration module 355. A user desirous to register with the system 300 disclosed herein can download an interface to their NFC enabled electronic device 420. The interface module 360 can be incorporated in the application software downloaded onto the NFC enabled electronic device 420. Alternatively, the interface module 360 can present the interface to a web browser of the NFC enabled electronic device 420. At step 510, the registration module can receive account details from a user. The account details can be of any account the user has with known social platforms such as an email account, Facebook account, and like. The registration module 355 can also receive permission to use the account details for secured verification of the user. Alternatively, the user can create a new account with the registration module 355. Once registered, the registration module 355 can generate a user profile, at step 520. The user profile can be filed by the user immediately or later. Once the user profile is registered, the user can register their NFC secured tag with the registration module, at step 530. The registration module 355 through the NFC and query module 365 can read the unique security code from the NFC secured tag, at step 540. The unique security code can then be associated, by the registration module 355, with the user profile, at step 550. Once the user registers with the system 300, the registration module 355 can create a user profile for the user. The user profile can include details of the user, such as a biodata of the user. The registration module 355 can also allow the user to update their profile later. The user profile once generated can be stored in the database 410 by the profile module 370.

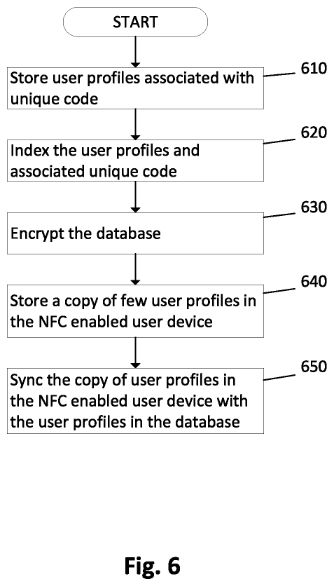

FIG. 6 shows an exemplary embodiment of the profile module 370. At step 610, the user profiles, generated at step 520 by the registration module 355, can be stored in the database 410. The stored user profiles with their associated secured unique security codes can then be indexed, at step 620. Indexing of the database allows for querying the database 410. The profile module 370 can also provide for encryption and decryption of the database for security concerns, at step 630. Although the above shows storing user profiles in the database 410, the profile module 370 can also store a copy of a few user profiles in an NFC enabled user device 420, at step 640. The few profiles can be the profile that the user has searched. Additionally, the interface can allow a user to manually save a copy of a user profile to his NFC enabled user device 420. The profile modules 370 can track any updates on the user profiles and notify the updates to the concerned users. The profile module 370 can also keep the copy of user profiles stored in the user's NFC enabled user device 420 in-sync with the original user profiles stored in the database 410, at step 650.

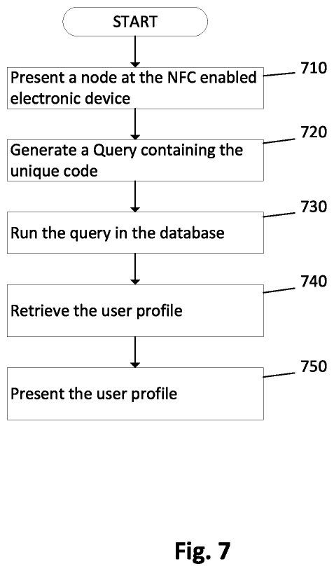

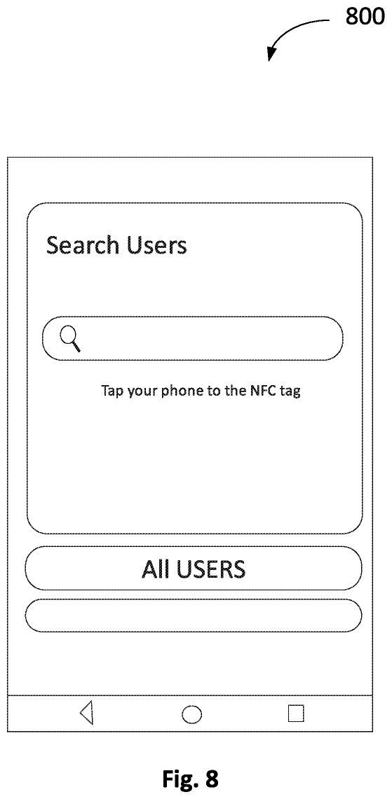

FIG. 7 shows an embodiment of the NFC and query module 365. At step, 710 the NFC and query module 365 can present a node at the NFC enabled electronic device through the interface. The node can allow the NFC enabled electronic device to read the NFC security tag and retrieve the unique security code from the NFC secured tag. A user can tap his NFC enabled electronic device 420 to the wearable device, such as a badge 100 shown in FIG. 1. FIG. 8 shows one implementation of interface 800 that allows a user to scan the NFC secured tag 310. The NFC and query module 365 can construct, from the unique security code, a query, at step 720. The NFC and query module 365 can receive the query from the NFC enabled electronic device 420 and run the query in the database 410 to retrieve the user profile from the database 410, at step 730. Once the specific user profile has been retrieved, step 740, the NFC and query module 365 can then present the user profile, onto the interface of the NFC enabled electronic device 420, at step 750.

The system disclosed herein can allow sharing personal profiles to other users during social interaction. A user can simply scan the NFC secured tag of another user and retrieve his personal profile. The system and method can allow salespersons to quickly share their contact information by presenting the badge. The salesperson on the other hand can quickly take the contact details of the customer by scanning their NFC secured tags. The present invention is further advantageous by avoiding any errors in taking contact information. The NFC secured tag can be used to identify a person, wherein the NFC secured tag can be scanned by the NFC and query module to retrieve the profile of the person to be identified. People no longer need to exchange paper-based business cards, which are easily misplaced or lost. Moreover, personal profiles can include product information to be advertised. Any interested user can simply scan the NFC secured tag to retrieve the personal profile containing the product information.

In one aspect, the system disclosed herein is secure. A user can retrieve a profile of another user only by scanning the NFC secured tag of another user. Moreover, the system may not allow a user to save the profile of another user in their devices either in the permanent memory or cache memory, to further enhance security and safeguarding confidentially of the user. The NFC secured tag is secured from hacking, cloning, and manipulation for preventing any fraud. The code can be encrypted, and the encryption can be hardware level to further secure the NFC secured tag. The security of data is further enhanced by allowing only authorized devices to read the NFC secured tag. In case, an NFC secured tag is lost, the user can report losing the NFC secured tag. The system upon receiving the request for lost NFC secured tag can block the NFC secured tag. The same procedure can be used in case the NFC secured tag is stolen. All measures to secure the system including the NFC secured tag to maintain confidentially of data are within the scope of the present invention. For example, compromised or unlocked user devices may not be allowed to read the NFC secured tags. All these measures makes the system secure.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A secured system for sharing a user profile comprising:
an NFC secured tag, the NFC secured tag containing a unique security code, the unique security code associated with a user profile, the NFC secured tag configured to be read by an NFC enabled electronic device;
a wearable accessory including the NFC secured tag.

2. The system of claim 1, wherein the system further comprises:
a database storing the user profile;
a server in electric communication with the database, the server including a processor and a memory in communication with the processor, wherein the memory stores a set of instructions executable by the processor, the set of instructions when executed by the processor, cause the processor to:
read the unique security code by the NFC enabled electronic device from the NFC secured tag;
receive the unique security code from the NFC enabled electronic device;
query the unique security code in the database;
retrieve the user profile associated with the unique security code from the database; and
present the user profile onto the NFC enabled electronic device.

3. The system of claim 2, wherein the wearable accessory is a badge, the badge having a fastener, the fastener configured to couple the badge with an article of clothing.

4. The system of claim 2, wherein the fastener is a clothes pin.

5. The system of claim 2, wherein the processor further:
authorize the NFC enabled electronic device to read the unique security code.

6. The system of claim 2, wherein the NFC enabled electronic device is a smartphone.

7. A method for sharing a user profile comprising:
providing a wearable accessory including the NFC secured tag, the NFC secured tag including the unique security code;
permitting, by the server, a first NFC enabled electronic device, to read the unique security code from the NFC secured tag;
receiving, by the server, from the first NFC enabled electronic device, the unique security code; and
associating, by a server, the unique security code with a user profile, the user profile stored in a database, the database connected to the server.

8. The method of claim 7, wherein the method further comprises:
permitting, by the server, a second NFC enabled electronic device, to read the unique security code from the NFC secured tag;
receiving, by the server, the unique security code;
querying the database, by the server, with the unique security code;
retrieve, by the server, the user profile associated with the unique security code from the database; and
present, by the server, the user profile onto the second NFC enabled electronic device.

9. The method of claim 7, wherein the first NFC enabled electronic device and the second NFC enabled electronic device are smartphones.

10. The method of claim 7, wherein the wearable accessory is a badge, the badge having a fastener, the fastener configured to couple the badge with an article of clothing.

11. The method of claim 10, wherein the fastener is a clothes pin.
